(19) United States
(12) Patent Application Publication
(10) Pub. No.: US 2008/0286547 A1
(43) Pub. Date: Nov. 20, 2008

(54) Polypropylene films with enhanced moisture barrier properties, process for making and composition thereof

(76) Inventors: Michael A. Hubbard, Pittsford, NY (US); Pang-Chia Lu, Pittsford, NY (US)

Correspondence Address: ExxonMobil Chemical Company;Law Technology, P.O. Box 2149, Baytown, TX, 77522-2149, US

(21) Appl. No.: 11/804,630

(22) Filed: May 18, 2007

(51) Int. Cl. B32B 27/32; C08K 5/09; C08K 5/16; C08K 5/50; C08L 23/10

(52) U.S. Cl. 428/220; 524/154; 524/236; 524/394; 524/570; 524/577; 524/579; 524/582; 525/240

(57) ABSTRACT

Multi-layer films particularly suited for packaging applications, including a core layer, the core layer having at least one nucleating agent and at least one water vapor transmission inhibitor are provided. Optionally, the multi-layer film may have at least one skin layer and at least one tie layer located intermediate the core layer and the at least one skin layer. Embodiments may have the advantage of superior barrier properties and very low water vapor transmission rates.

### FIELD OF THE INVENTION

This invention relates to polypropylene films, such as biaxially oriented polypropylene films, a process for manufacturing these polypropylene films, and the composition thereof. Of particular significance in this disclosure are the compositional changes imposed on polypropylene films by the homogeneous addition of certain additives to the polymer melt. These additives augment many of the native polymer physical properties, but especially, it has been found, act to improve the moisture barrier properties of the polypropylene film over polypropylene film moisture barrier properties known in the art heretofore.

### BACKGROUND OF THE INVENTION

Polyolefin films, especially polypropylene based films, are widely used in commercial applications, especially food packaging, because of their low cost and advantageous physical properties. Films of polypropylene are strong enough to withstand ordinary handling in the machine packaging process and the polymer melt itself adapts well to state-of-the-art film forming manufacturing processes. However, the barrier properties of native polypropylene film are another matter. These properties may be an advantage or a disadvantage depending on the requirements of the packaged material. Some packaged foodstuffs may need a film with high oxygen permeability for the product to ripen in the shelved package. The high oxygen permeability of polypropylene film recommends them for these applications. However, if packaged products, such as fruit or candy, become stale due to water vapor transmission, then polypropylene film is not preferred for packaging unless corrective measures are taken to reduce water vapor transmission rate (WVTR) through the film to protect the quality of the enclosed product.

The propylene polymers normally employed in the prior art preparation of biaxially oriented films are isotactic homopolymers with high stereoregularity, although on some occasions the use of syndiotactic polymers has been proposed. Isotactic polypropylene is one of a number of crystalline polymers that can be characterized in terms of the stereoregularity of the polymer chain. The structure of isotactic polypropylene is characterized by a large majority of the methyl groups of the recurring linear addition propylene polymer units being all above or all below the plane of the polymer chain. The resultant stereoregularity of the polypropylene polymer promotes high crystallinity in the propylene polymer and a favorable enhancement of physical and chemical properties.

In contrast to the isotactic structure discussed above, syndiotactic propylene polymers are those in which the methyl groups attached to the tertiary carbon atoms of successive monomeric units in the polymer chain lie on alternate sides of the plane of the polymer. Syndiotactic polymers are semi-crystalline and, like isotactic polymers, are insoluble in xylene. This crystallinity distinguishes both syndiotactic and isotactic polymers from atactic polymers, which are very low in crystallinity and highly soluble in xylene. Atactic propylene polymers exhibit no regular order of repeating unit configurations in the polymer chain and form essentially a waxy product.

Nucleating agents may be incorporated into oriented polypropylene films to improve the mechanical properties of the film, but heretofore it has not been known that such incorporation could also improve barrier properties. Recent attempts to incorporate nucleating agents into oriented polypropylene films using standard compounding techniques to create nucleating agent masterbatches have resulted in films with generally poor nucleating agent distribution and similar or higher water vapor transmission rates than non-nucleated films.

Nucleating agents may also be utilized in polypropylene film manufacturing to increase the stiffness of the resulting film and further, may also improve the optical and barrier properties of films. Various nucleating agents are suitable for use with polypropylene materials. For example, U.S. Pat. Nos. 5,300,549 and 5,319,012 to Ward et al. (the Ward patents), both of which are incorporated herein in their entireties by specific reference thereto, disclose the use of dicarboxylic and monocarboxylic acids for the subsequent manufacture of shaped articles. U.S. Pat. No. 5,856,386 to Sakai et al., which is incorporated herein in its entirety by specific reference thereto, uses rosin acid metallic salts as a nucleating system.

U.S. Pat. No. 6,953,617, to DeMeuse, the subject matter of which is incorporated herein in its entirety by specific reference thereto, discloses the use of a nucleated isotactic polypropylene with the product identification FF035C (available from Sunoco Co., of Pittsburgh, Pa.).

Most nucleating agents (e.g., sodium benzoate and talc) are particulate in nature, and may be ground to an appropriate particle size for use in polyolefins. For example, some nucleating agents may have a particle size distribution including a mean size of 2 microns and a maximum size of 10 microns. Nucleating agents may also be non-particulate. It can be difficult to disperse nucleating agents into a polymer for effective homogeneous nucleation, even when added in small quantities. The appearance of crystallization characteristics in a film following addition of a nucleating agent, in most cases, occurs very rapidly. In such cases, particularly when the nucleating agent is not uniformly distributed throughout the polymer, the film tends to break during orientation processes.

U.S. Patent Application Publication No. 2003/0211298, the subject matter of which is incorporated herein in its entirety by specific reference thereto, discloses polypropylene films with a modified core comprising isotactic polypropylene, a polymeric modifier, and a hydrocarbon resin.

U.S. Patent Application Publication No. 2004/0170854, the subject matter of which is incorporated herein in its entirety by specific reference thereto, discloses films that contain a base or core layer comprising a first polypropylene, a second polypropylene, and a hydrocarbon resin. The base layers may also include other additives. The '854 publication also discloses that film additives such as cling agents, antiblock agents, antioxidants, slip additives, pigments, fillers, processing aids, UV stabilizers, neutralizers, lubricants, surfactants and/or nucleating agents may be present in one or more layers of a film.

As noted above, there is a critical need not met in the prior art to provide a polypropylene barrier film that has the physical and chemical properties to survive the stress of film forming manufacturing requirements, particularly biaxial orientation, while displaying very low water vapor transmission characteristics. It has been discovered that improved polypropylene films, including biaxially oriented polypropylene (BOPP) films, may be formed using uniformly dispersed nucleating agents and a water vapor transmission inhibitor, for example hydrocarbon resin. When a nucleating agent and water vapor transmission inhibitor are provided in sufficient quantities and the nucleating agent is appropriately dispersed throughout the polymer, the films of the current invention provide superior barrier properties and very low water vapor transmission rates, particularly in comparison to films containing only a nucleating agent, only a water vapor transmission inhibitor, or both a water vapor transmission inhibitor and a poorly dispersed nucleating agent.

### SUMMARY OF THE INVENTION

The present invention generally relates to compositions useful for the production of polypropylene films, preferably biaxially oriented polypropylene films, having superior barrier film properties, particularly low water vapor transmission rates.

In one embodiment, the invention generally relates to a polymeric film comprising a core layer comprising polypropylene, a nucleating agent and a hydrocarbon resin, wherein the core layer has a first side and a second side, the nucleating agent and the hydrocarbon resin being present in amounts sufficient to lower the average moisture permeability coefficient of the film in comparison to the average moisture permeability coefficient of the film in the absence of either or both the nucleating agent and the hydrocarbon resin.

In another embodiment, the invention generally relates to a method for manufacturing a multi-layer polymeric film, comprising forming a multi-layer film by coextruding at least a first skin layer, a core layer and a second skin layer, the core layer comprising polypropylene, a nucleating agent and a hydrocarbon resin, orienting the film in a machine direction and orienting the film in a transverse direction.

In yet another embodiment, the invention generally relates to a polymeric barrier film including a core layer comprising a polypropylene resin having a nucleating agent substantially uniformly dispersed therein and at least one hydrocarbon resin, wherein the polymeric barrier film has an average moisture permeability coefficient that is lower than the average moisture permeability coefficient of the polymeric barrier film in the absence of either or both the nucleating agent and the hydrocarbon resin.

In still another embodiment, the invention generally relates to a polypropylene film comprising a first skin layer, a second skin layer and a core layer comprising about 85 percent by weight of a nucleated isotactic polypropylene and about 15 percent by weight of a hydrocarbon resin.

Another embodiment of the invention generally relates to a process of making a polymeric barrier film comprising preparing a first skin layer and a second skin layer, and preparing a core layer comprising about 85 percent by weight of a nucleated isotactic polypropylene and adding to the core layer about 15 percent by weight of a hydrocarbon resin.

Still further, another embodiment of the invention generally relates to a polymeric barrier film including a core layer comprising a polypropylene resin having a nucleating agent substantially uniformly dispersed therein, and at least one additive, other than the nucleating agent, comprising at least one water vapor transmission inhibitor in an amount sufficient to lower the average moisture permeability coefficient of the polymeric barrier film in comparison to the average moisture permeability coefficient of the polymeric barrier film in the absence of at least one water vapor transmission inhibitor.

In yet another embodiment, the invention generally relates to a process of making a polymeric barrier film, comprising adding to at least one layer of a nucleated polypropylene film, at least one water vapor transmission inhibitor in an amount sufficient to lower the average moisture permeability coefficient of the polymeric barrier film in comparison to the average moisture permeability coefficient of the polymeric barrier film in the absence of at least one water vapor transmission inhibitor.

The films of the current invention can exhibit a significantly lower water vapor transmission rate than conventional polypropylene films of identical thickness, but absent the nucleating agent and/or water vapor transmission inhibitor employed herein, or with a poorly distributed nucleating agent.

### DETAILED DESCRIPTION OF THE INVENTION

The specific embodiments, versions and examples of the invention will now be described. While the following detailed description gives specific preferred embodiments, those skilled in the art will appreciate that these embodiments are exemplary only, and that the invention can be practiced in other ways. No attempt is made to show structural details of the filns of this disclosure in more detail than is necessary for the fundamental understanding thereof, the description making apparent to those skilled in the art how the several forms of the inventive films may be embodied in practice. For purposes of determining infringement, the scope of the invention will refer to the appended claims and elements or limitations that are equivalent to those that are recited. Any reference to the “invention” may refer to one or more, but not necessarily all, of the embodiments defined by the claims.

According to this disclosure, a water vapor transmission inhibitor, for example hydrocarbon resin, can be combined with a nucleated polypropylene resin to produce a polypropylene film, for example an oriented polypropylene film, that can have a lower water vapor transmission rate than control films absent either or both of the nucleating agent and the water vapor transmission inhibitor or with a poorly distributed nucleating agent. Films having low WVTR are useful in applications requiring good moisture barriers.

According to one aspect of this disclosure, a biaxially oriented polypropylene film having a substantially uniformly dispersed nucleating agent and a water vapor transmission inhibitor, for example hydrocarbon resin, has been shown to display substantially improved moisture barrier properties relative to films incorporating only a nucleating agent, only a hydrocarbon resin or with the combination of a hydrocarbon resin and a poorly dispersed nucleating agent.

Films according to this invention comprise an arrangement of polymeric layers that contribute individually and collectively to the improved moisture barrier properties. In the films of this invention, a nucleating agent and a water vapor transmission inhibitor are incorporated into a core layer to facilitate the advantages stated above.

In a preferred embodiment, this invention relates to a polymeric film comprising a core layer comprising polypropylene, a nucleating agent and a hydrocarbon resin, wherein the core layer has a first side and a second side, the nucleating agent and the hydrocarbon resin being present in amounts sufficient to lower the average moisture permeability coefficient of the film in comparison to the average moisture permeability coefficient of the film in the absence of either or both the nucleating agent and the hydrocarbon resin.

According to some embodiments of this disclosure, the polypropylene film can have a PH_{H2O} moisture transmission coefficient less than 4.0 g mil/m² day. Alternatively, the film can have a PH_{H2O} moisture transmission coefficient less than 3.0 g mil/m² day. Preferably, the film can have a PH_{H2O} moisture transmission coefficient less than 2.8 g mil/m² day.

The films according to this invention may have a total thickness ranging from about 5 microns (0.2 mil) to about 125 microns (5 mil), preferably from about 10 microns (0.4 mil) to about 62.5 microns (2.5 mil), more preferably from about 10 microns (0.4 mil) to about 40 microns (1.6 mil). The thickness relationship of the layers can be important. For example, the core layer may constitute a suitable percentage of the total film thickness, for example the core layer can be from about 40% to about 100% of the total film thickness. Any tie layers can have a thickness ranging from greater than 0% to about 30% of the total film thickness while the first skin layer and second skin layer of the film can have a thickness ranging from greater than 0% to about 10% of the total film thickness.

The basic film structure used to demonstrate this invention may be a clear, transparent film and may comprise three layers such as a core layer, a first skin layer and a second skin layer, although it would be apparent to one skilled in the art that opaque films (including cavitated films) or films with different numbers of layers may be used as well. Inventive and comparative film structures used to demonstrate the present invention are shown schematically in Structures 1-9 of the examples and are discussed in detail below.

### Core Layer

As is known to those skilled in the art, the core layer of a multi-layered film is most commonly the thickest layer and provides the foundation of the multi-layer structure. The core layer of the multi-layer film according to the present invention comprises a film-forming polyolefin, such as, for example, polypropylene. Polypropylenes suited for use with the current invention include high crystallinity polypropylene, low crystallinity polypropylene, isotactic and syndiotactic polypropylene. In preferred embodiments, the core layer may comprise isotactic polypropylene or syndiotactic polypropylene. The polypropylene of the core layer additionally includes at least one nucleating agent.

Polypropylenes suitable for use in the core layer of the current invention include, for example, polypropylene FF035C, a nucleated polypropylene resin commercially available from Sunoco Chemicals of Pittsburg, Pa. Film samples utilizing FF035C in the core layer are described schematically in Structures 2 and 3 in the examples below.

An exemplary nucleating agent for use in the polypropylene of the core layer can be one that induces crystallization at a temperature near the polypropylene melting point but by itself is solid at such a temperature. In other words, a good nucleating agent could be an organic material that has a melting point above that of polypropylene and is compatible with polypropylene at melting conditions.

Extremely high melting point materials or ground inorganic materials may be used as nucleating agents in the present invention. The use of organic materials may be advantageous under extrusion conditions because high melting point organic materials may be non-particulate and as such may be more readily and uniformly dispersed into the polypropylene melt. Upon cooling, the organic material will first solidify at the molecular level throughout the polypropylene melt matrix. In this manner, a true nucleating effect can be obtained.

The above-mentioned Sunoco polypropylene resin includes a nucleating agent that may be non-particulate and is believed to be a mix of carboxylic acids. Additionally, there are a number of nucleating agents known in the art that would be expected to perform in a similar manner to the Sunoco resin, if the nucleating agents are sufficiently well dispersed throughout the resin. For example, U.S. Pat. No. 6,733,719, the entire subject matter of which is incorporated herein by specific reference thereto, discloses a polypropylene product with nucleating systems that are believed to be appropriate for utilization in this invention. The previously mentioned Ward patents also disclose nucleating agents appropriate for utilization in this invention.

Other nucleating agents that can be utilized in the films of this disclosure can be 2,4, dimethylbenzilidene sorbitol (commercially available as MILLADO® 3988 from Milliken Chemicals, a division of Milliken & Company), sodium 2,2′-methylene bis(4,6-di-tert-butylphenyl)phosphate (commercially available as IRGASTAB® NA 11 by Ciba Specialty Chemicals of Basel, Switzerland), disodium (1R, 2R, 3S, 4S)-rel-bicyclo[2.2.1]heptane-2,3-dicarboxylic acid (commercially available as HYPERFORMS® HPN-68L from Milliken Chemicals, a division of Milliken & Company), N,N′-dicyclohexyl-2,6-naphthalenecarboxamide and the family of substituted 1,3,5-benzenetrisamides. Combinations of these nucleating agents may also be used.

Polypropylene may be present in the core layer in an amount ranging from about 70 weight percent to about 95 weight percent, preferably from about 85 weight percent to about 95 weight percent.

Nucleating agents may be present in the polypropylene resin of the core layer in an amount of up to about 3000 ppm (parts-per-million) by weight, preferably from about 25 ppm to about 1000 ppm by weight and more preferably from about 50 ppm to about 200 ppm by weight.

The core layer of the present invention further comprises at least one water vapor transmission inhibitor. Preferred water vapor transmission inhibitors for use in this invention include microcrystalline waxes and hydrocarbon resins. Water vapor transmission inhibitors should be present in the core layer in an amount sufficient to lower the average moisture permeability coefficient of the film.

The water vapor transmission inhibitors employed in this disclosure may be low molecular weight hydrocarbon resins that may be compatible with polypropylene polymers and provide the desired enhancement of film properties. An exemplary resin modifier has a suitable number average molecular weight, for example a number average molecular weight less than about 5000, preferably less than about 2000, and more preferably from about 500 to about 1000. The resin modifier can be natural or synthetic and can have a suitable softening point, for example of from about 60° C. to about 180° C., preferably from about 80° C. to 130° C. (as determined according to ASTM-E 28). Exemplary hydrocarbon resins can include petroleum resins, terpene resins, styrene resins, cyclopentadiene resins and saturated alicyclic resins, among others.

Suitable petroleum resins to be utilized herein can be prepared in the presence of a catalyst and by polymerization of highly cracked petroleum materials. These petroleum materials can contain a mixture of resin-forming substances such as ethylindene, butadiene, isoprene, piperylene, pentylene, polystyrene, methylstyrene, vinyltoluene, indene, polycyclopentadiene, polyterpenes, polymers of hydrogenated aromatic hydrocarbons, alicyclic hydrocarbon resins, and combinations thereof.

The terpene resins can be polymers of terpenes, i.e., hydrocarbons of the formula, C₁₀H₁₆ that are present in almost all ethereal oils or oil-containing resins in plants, and phenol-modified terpene resins. Alpha-pinene, beta-pinene, dipentene, limonene, myrcene, camphene, and similar terpenes are some examples of terpenes polymerized into resins.

The styrene resins can be homopolymers of styrene or copolymers of styrene with other monomers, such as, for example, alpha methylstyrene, vinyltoluene, and butadiene.

The cyclopentadiene resins can be cyclopentadiene homopolymers or cyclopentadiene copolymers, that are obtained from coal-tar distillates and fractionated natural gas. These resins can be prepared by reacting the cyclopentadiene-containing materials at a high temperature, for example in the presence of a catalyst.

Preferably, the hydrocarbon resin is a saturated alicyclic hydrocarbon resin. Saturated alicyclic hydrocarbon resins utilized in the films of this disclosure can be obtained by hydrogenation of aromatic hydrocarbon resins. The aromatic resins can be obtained by polymerizing reactive unsaturated hydrocarbons containing aromatic hydrocarbons in which reactive double bonds are generally in side-chains. The saturated alicyclic resins can be obtained from the aromatic resins by hydrogenating the latter until all, or almost all, of the unsaturation has disappeared, including the double bonds in the aromatic rings. Although exemplary aromatic hydrocarbons useful in the preparation of the alicyclic resins can be compounds containing reactive double bonds in side-chains, they may also comprise aromatic hydrocarbons having reactive double bonds in condensed ring systems. Examples of such useful aromatic hydrocarbons include vinyltoluene, vinylxylene, propenylbenzene, styrene, methylstyrene, indene, methylindene and ethylindene. Mixtures of several of these hydrocarbons may also be used. Examples of commercially available alicyclic resins suitable for use in the present invention are those sold under the trademark ARKON® by Arakawa Chemical Industries, Ltd. of Osaka, Japan.

Examples of commercially available hydrogenated hydrocarbon resins suitable for use in this disclosure can be those sold under the trademarks PICCOLYTE® by Hercules Incorporated of Wilmington, Del., REGALREZ® and REGALITE® by Eastman Chemical Company of Kingsport, Tenn. and under the trademarks ESCOREZ® and OPPERA® PA610A by ExxonMobil Chemical Company of Houston, Tex.

Water vapor transmission inhibitors may be present in the core layer in an amount up to about 30 weight percent, preferably from about 2 weight percent to about 15 weight percent, more preferably from about 3 weight percent to about 10 weight percent, relative to the core layer.

In one embodiment, the core layer of the films of the current invention may be made, for example, with Sunoco FF035C, which contains a nucleating agent and, for example, OPPERA® PA610A (commercially available from ExxonMobil Chemical company of Houston, Tex.), a hydrocarbon resin used as a water vapor transmission inhibitor. U.S. Patent Application Nos. 2003/0211298 and 2004/0170854 also disclose hydrocarbon resins that may be appropriate for utilization in the films disclosed herein.

The nucleating agent and water vapor transmission inhibitor according to the present invention may be substantially evenly distributed or dispersed at least laterally throughout the polypropylene film. The nucleating agent incorporated into the polypropylene film may be present in an amount, for example, of up to about 3000 ppm (parts-per-million) of the polypropylene resin of the core layer or, for example, in an amount of about 25 ppm to about 1000 ppm or, for example, in an amount of about 50 ppm to about 200 ppm. The water vapor transmission inhibitor may be present in an amount, for example, of up to about 30 weight percent, preferably up to about 15 weight percent of the polypropylene film.

The thickness of the core layer of the current invention is typically in the range of from about 5 microns (20 ga.) to about 27.5 microns (110 ga.), preferably from about 15 microns (60 ga.) to about 20 microns (80 ga.).

### Skin Layers

Some embodiments of the current invention comprise three layers, including a core layer, a first skin layer and a second skin layer. Exemplary polymers for use in the first skin layer and the second skin layer may include any film-forming polyolefins commonly known in the art including, but not limited to low density polyethylene, linear low density polyethylene, medium density polyethylene, high density polyethylene, ethylene-propylene copolymers, butylene-propylene copolymers, ethylene-butylene copolymers, ethylene-propylene-butylene terpolymers, syndiotactic polypropylene, ethylene-vinyl acetate copolymers, ethylene-vinyl alcohol copolymers, polyvinyl alcohols, nylons, polyesters, polyamides, graft copolymers and combinations thereof. One example of an ethylene-propylene-butylene terpolymer suitable for use in the current invention is XPM 7510, commercially available from Japan Polypropylene Corporation of Tokyo, Japan.

Each skin layer can have a thickness in a range of from about 0.25 microns (1 ga.) to about 2 microns (8 ga.).

In some embodiments of the current invention, the polymers and thickness of the first skin layer and the second skin layer may be substantially the same. In other embodiments of the invention, the polymers and thickness of the first skin layer may be different from the polymers and thickness of the second skin layer.

### Additional Layers

There can be more than one layer co-extruded on each side of the core layer. That is, one or more layers may be present on one or both surfaces of the core layer. The additional layer or layers may be positioned intermediate the core layer and either or both of the first skin layer and the second skin layer.

Such structures may be represented, in simplified form, as having a structure “ABCDE” where “C” represents a core layer. “B” and “D” represent intermediate layers wherein layer “B” is adjacent to the core layer and wherein layer “D” is adjacent to the core layer on the side opposite layer “B”. “A” and “E” represent a first skin layer and second skin layer, respectively. Layer “A” is positioned on the outer surface of intermediate layer “B” on a side opposite the core layer. Layer “E” is positioned on the outer surface of intermediate layer “D” on a side opposite the core layer. In such a film structure, the intermediate layers “B” and “D” may be referred to as “intermediate layers” or “tie-layers.” The components of first skin layer “A” and tie layer “B” may be the same or different from one another. Similarly, the components of tie layers “B” and “D” may be the same or different. The components of tie layer “D” and second skin layer “E” may also be the same or different. First skin layer “A” and second skin layer “E” may be the same or different as well. In some embodiments, one or more of any of the layers above may be absent. Additionally, structures containing more than five layers are contemplated, e.g., six, seven, eight, nine, and more layers are contemplated.

Any tie layers present in the films of this disclosure can be any co-extrudable, biaxially orientable and other film-forming resins known in the art. Such materials include, but are not limited to, syndiotactic polypropylene, low density polyethylene (LDPE), linear low density polyethylene (LLDPE), medium density polyethylene (MDPE), high density polyethylene (HDPE), ethylene-propylene copolymers, butylene-propylene copolymers, ethylene-butylene copolymers, ethylene-propylene-butylene terpolymers, ethylene-vinyl acetate copolymers, ethylene-vinyl alcohol copolymers, nylons, polymers grafted with functional groups, appropriate blends of these, and others known to those skilled in the art.

Each tie layer can have a thickness in a range of from about 0.125 microns (0.005 mil) to about 25 microns (1 mil), and for example from about 0.5 microns (0.02 mil) to about 12.5 microns (0.50 mil).

### Additives

In order to modify or enhance certain properties of the multi-layer films of this disclosure for specific end-uses, it is possible for one or more of the layers to contain appropriate additives in effective amounts. Preferred additives include, but are not limited to opacifying agents, pigments, colorants, cavitating agents, slip agents, antioxidants, anti-fog agents, anti-block agents, anti-static agents, fillers, processing aids, clarifiers, and other additives known to those skilled in the art. Such additives may be used in effective amounts, which vary depending upon the property required.

Examples of suitable opacifying agents, pigments or colorants are iron oxide, carbon black, aluminum, titanium dioxide (TiO₂), calcium carbonate (CaCO₃), polybutylene terephthalate (PBT), talc, beta nucleating agents, and combinations thereof.

Cavitating or void-initiating additives may include any suitable organic or inorganic material that is incompatible with the polymer material(s) of the layer(s) to which it is added, at the temperature of biaxial orientation, in order to create an opaque film. Examples of suitable void-initiating particles are PBT, nylon, solid or hollow pre-formed glass spheres, metal beads or spheres, ceramic spheres, calcium carbonate, talc, chalk, or combinations thereof. Cavitation may also be introduced by beta-cavitation, which includes creating beta-form crystals of polypropylene and converting at least some of the beta-crystals to alpha-form polypropylene crystals and creating a small void remaining after the conversion. Preferred beta-cavitated embodiments of the core layer may also comprise a beta-crystalline nucleating agent. Substantially any beta-crystalline nucleating agent (“beta nucleating agent” or “beta nucleator”) may be used. The average diameter of the void-initiating particles typically may be from about 0.1 to 10 μm.

Slip agents may include higher aliphatic acid amides, higher aliphatic acid esters, waxes, silicone oils, and metal soaps. Such slip agents may be used in amounts ranging from 0.1 wt % to 2 wt % based on the total weight of the layer to which it is added. An example of a slip additive that may be useful for this invention is erucamide.

Non-migratory slip agents, used in one or more skin layers of the multi-layer films of this invention, may include polymethyl methacrylate (PMMA). The non-migratory slip agent may have a mean particle size in the range of from about 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAR™ (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkyl siloxane, such as silicone oil or gum additive having a viscosity of 10,000 to 2,000,000 centistokes is also contemplated.

Suitable anti-oxidants may include phenolic anti-oxidants, such as IRGANOX® 1010 (commercially available from Ciba-Geigy Company of Switzerland). Such an anti-oxidant is generally used in amounts ranging from 0.1 wt % to 2 wt %, based on the total weight of the layer(s) to which it is added.

Anti-static agents may include alkali metal sulfonates, polyether-modified polydiorganosiloxanes, polyalkylphenylsiloxanes, and tertiary amines. Such anti-static agents may be used in amounts ranging from about 0.05 wt % to 3 wt %, based upon the total weight of the layer(s).

Examples of suitable anti-blocking agents may include silica-based products such as SYLOBLOC® 44 (commercially available from Grace Davison Products of Colombia, Md.), PMMA particles such as EPOSTAR™ (commercially available from Nippon Shokubai Co., Ltd. of Japan), or polysiloxanes such as TOSPEARL™ (commercially available from GE Bayer Silicones of Wilton, Conn.). Such an anti-blocking agent comprises an effective amount up to about 3000 ppm of the weight of the layer(s) to which it is added.

Fillers useful in this invention may include finely divided inorganic solid materials such as silica, fumed silica, diatomaceous earth, calcium carbonate, calcium silicate, aluminum silicate, kaolin, talc, bentonite, clay and pulp.

### Surface Treatment

One or both of the outer surfaces of the multi-layer films of this invention may be surface-treated to increase the surface energy to render the film receptive to metallization, coatings, printing inks and/or lamination. The surface treatment can be carried out according to one of the methods known in the art including corona discharge, flame, plasma, chemical treatment, or treatment by means of a polarized flame. Additionally, surface treatments according to this invention may include successive steps incorporating several methods (i.e., corona treatment followed by plasma treatment, flame treatment followed by plasma treatment, etc.)

### Metallization

One or both of the outer surfaces of the multi-layer films of this invention may be metallized. Such layers may be metallized using conventional methods, such as vacuum metallization by deposition of a metal layer such as aluminum, copper, silver, chromium or mixtures thereof.

### Coatings/Primers

Coatings may be applied to one or both of the exposed surfaces of the outermost (skin) layers of the film. Such coatings may be utilized to protect the underlying film surfaces. Prior to application of the coating material, the film may be surface treated, as discussed above, or may be primed with a primer layer. Appropriate coatings contemplated include acrylic coatings such as those described in U.S. Pat. Nos. 3,753,769 and 4,865,908, both of which are incorporated herein by reference, and PVdC coatings such as those described in U.S. Pat. Nos. 4,214,039; 4,447,494; 4,961,992; 5,019,447 and 5,057,177, all of which are incorporated herein by reference. A vinyl alcohol polymer may also be used as a coating composition, such as VINOL® 325, commercially available from Air Products and Chemicals, Inc. or CELVOL® 325 from Celanese Chemicals of Dallas, Tex.

Appropriate primer materials for use with the films of the current invention include poly(ethyleneimine), epoxy primers, and other such primers known to those skilled in the art.

### Orientation

According to an aspect of this disclosure, all layers of the multi-layer film structures can be co-extruded. Thereafter, the film can be uniaxially or biaxially oriented. Specifically, the polymers can be brought to the molten state and co-extruded from a conventional extruder through a flat sheet die, the melt streams can be combined in an adapter prior to being extruded from the die or within the die. After leaving the die, the multi-layer web can be chilled and the quenched web can be reheated for orientation. Orientation in the direction of extrusion is known as machine direction (MD) orientation. Orientation perpendicular to the direction of extrusion is known as transverse direction (TD) orientation. Orientation may be accomplished by stretching or pulling a film first in the MD followed by the TD. Blown or cast films may also be oriented by a tenter-frame orientation subsequent to the film extrusion process, again in one or both directions. Orientation may be sequential or simultaneous, depending upon the desired film features.

The film can be oriented by stretching from, for example, about 3 to about 11 times in the machine direction (MD) at a suitable temperature, for example at temperatures ranging from about 105° C. to about 150° C. and, for example from about 3 to about 12 times in the transverse direction (TD) at a suitable temperature, for example at temperatures ranging from about 150° C. to about 165° C.

Preferred orientation ratios for the films of the current invention may be, for example in the range of from four to ten times in the machine direction and from about seven to twelve times the extruded width in the transverse direction. Typical commercial orientation processes include, but are not limited to, BOPP tenter processes, blown film, double-bubble and LISIM technology.

### Experimental

The multi-layer films of the present invention will be further described with reference to the following non-limiting examples.

### Testing Methods

As used herein, water vapor transmission rate (WVTR) may be measured by a reliable method such as ASTM F1249. In particular, WVTR may be measured with a MOCON® PERMATRAN W700 instrument, available from MOCON Inc., Minneapolis, Minn. Typically moisture barrier measurements are reported as a permeation rate. Typically, moisture transmission rates are reported in terms of mass of water per unit area per unit time, for example g/[m² day], for a film of a given thickness. However, because the moisture permeation rate is linearly dependent upon the thickness of the film it can also be useful to normalize for film thickness and thus be able to compare the relative intrinsic permeability of the materials comprising the film. This is accomplished by multiplying the permeation rate by the thickness of the film and reporting a moisture permeability coefficient (P_{H2O}). One commonly used set of units for P_{H2O} is g mil/[m² day].

References herein to t-values refer to the result of the t-test to determine the significance of the difference between two independent sample means. The t-test evaluates the null hypothesis that two samples sets derive from populations having the same underlying means. T-values greater than 2.0 indicate that the null hypotheses can be rejected with 90% confidence.

### EXAMPLES

All film structures provided in the examples below are three-layer, biaxially oriented polypropylene films comprising a first skin layer, a second skin layer and a core layer. Structure 2 and Structure 3 are the exemplary films of the current invention, while Structure 1 and Structures 4-9 are comparative.

| Structure 1 (Comparative) | | Structure 2 (Exemplary) | | Structure 3 (Exemplary) | |
|---|---|---|---|---|---|
| 100% XPM 7510 | ~0.75μ | 100% XPM 7510 | ~0.75μ | 100% XPM 7510 | ~0.75μ |
| | (~0.03 mil) | | (~0.03 mil) | | (~0.03 mil) |
| 100% Sunoco FF035C | ~16.0μ | 85% Sunoco FF035C | ~16.0μ | 70% Sunoco FF035C | ~16.0μ |
| | (~0.64 mil) | 15% Oppera PA610A | (~0.64 mil) | 30% Oppera PA610A | (~0.64 mil) |
| 100% XPM 7510 | ~0.75μ | 100% XPM 7510 | ~0.75μ | 100% XPM 7510 | ~0.75μ |
| | (~0.03 mil) | | (~0.03 mil) | | (~0.03 mil) |
| Structure 4 (Comparative) | | Structure 5 (Comparative) | | Structure 6 (Comparative) | |
| 100% XPM 7510 | ~0.75μ | 100% XPM 7510 | ~0.75μ | 100% XPM 7510 | ~0.75μ |
| | (~0.03 mil) | | (~0.03 mil) | | (~0.03 mil) |
| 100% EM PP4712E1 | ~16.0μ | 85% EM PP4712E1 | ~16.0μ | 70% EM PP4712E1 | ~16.0μ |
| | (0.64 mil) | 15% Oppera PA610A | (~0.64 mil) | 30% Oppera PA610A | (~0.64 mil) |
| 100% XPM 7510 | ~0.75μ | 100% XPM 7510 | ~0.75μ | 100% XPM 7510 | ~0.75μ |
| | (~0.03 mil) | | (~0.03 mil) | | (~0.03 mil) |
| Structure 7 (Comparative) | | Structure 8 (Comparative) | | Structure 9 (Comparative) | |
| 100% XPM 7510 | ~0.75μ | 100% XPM 7510 | ~0.75μ | 100% XPM 7510 | ~0.75μ |
| | (~0.03 mil) | | (~0.03 mil) | | (~0.03 mil) |
| 97% EM PP4712E1 | ~16.0μ | 82% EM PP4712E1 | ~16.0μ | 67% EM PP4712E1 | ~16.0μ |
| 3% Millad 8C41 | (~0.64 mil) | 15% Oppera PA610A | (~0.64 mil) | 30% Oppera PA610A | (~0.64 mil) |
| | | 3% Millad 8C41 | | 3% Millad 8C41 | |
| 100% XPM 7510 | ~0.75μ | 100% XPM 7510 | ~0.75μ | 100% XPM 7510 | ~0.75μ |
| | (~0.03 mil) | | (~0.03 mil) | | (~0.03 mil) |

EM = ExxonMobil

The thickness of each corresponding layer of each of the nine sample films is the approximately the same. For example, the thickness of each first skin layer and each second skin layer measures about 0.75 microns (3 ga.) and each core layer is about 16 microns (64 ga.) thick.

The composition of the core layer of the foregoing film structures is as follows:

Sunoco FF035 is a nucleated isotactic polypropylene resin commercially available from Sunoco Chemicals, Pittsburgh, Pa. PP4712E1 is a polypropylene homopolymer commercially available from ExxonMobil Chemical Company of Houston, Tex. OPPERA® PA610A is a hydrocarbon resin commercially available from ExxonMobil Chemical Company of Houston, Tex. MILLAD® 8C41 is a masterbatch of MILLAD® 3988 (10%) in a random ethylene/propylene copolymer. MILLAD® 3988 is 2,4-dimethylbenzylidene sorbitol commercially available from Milliken Chemicals, a division of Milliken & Company of Spartanburg, S.C. A level of 3% MILLAD® 8C41 is equivalent to 0.3% MILLAD® 3988.

The first skin layer and second skin layer compositions are XPM 7510, a terpolymer of ethylene, propylene and 1-butene commercially available from Japan Polypropylene Corporation of Tokyo, Japan.

Table 1, below, shows average moisture permeability coefficients (P_{H2O}) corresponding to each of the nine sample structures above. The average P_{H2O} was calculated from the data of multiple samples prepared and tested for each of the nine structures, as provided in Table 1. Specifically, the average P_{H2O} is calculated from the measured WVTR and thicknesses. Standard deviations are also provided in the table.

TABLE 1

| | | | | Calculated | Measured WVTR | Calculated | Average | |
|---|---|---|---|---|---|---|---|---|
| | | Millad | Oppera | thickness | (100° F., 90% RH) | P_{H2O} | P_{H2O} | |
| Structure | Core | 8C41 | PA610A | (mil) | (g/[m² day]) | (g/[m² day]) | (g/[m² day]) | σ |
| 1 | FF035C | None | None | 0.70 | 5.31 | 3.70 | 3.85 | 0.14 |
| | FF035C | None | None | 0.75 | 5.00 | 3.77 | | |
| | FF035C | None | None | 0.76 | 5.27 | 4.01 | | |
| | FF035C | None | None | 0.74 | 5.30 | 3.92 | | |
| 2 | FF035C | None | 15% | 0.70 | 4.22 | 2.96 | 3.06 | 0.11 |
| | FF035C | None | 15% | 0.70 | 4.56 | 3.19 | | |
| | FF035C | None | 15% | 0.71 | 4.36 | 3.11 | | |
| | FF035C | None | 15% | 0.72 | 4.15 | 2.97 | | |
| 3 | FF035C | None | 30% | 0.69 | 3.92 | 2.69 | 2.79 | 0.15 |
| | FF035C | None | 30% | 0.68 | 4.06 | 2.75 | | |
| | FF035C | None | 30% | 0.67 | 4.49 | 3.01 | | |
| | FF035C | None | 30% | 0.68 | 3.94 | 2.69 | | |
| 4 | PP4712E1 | None | None | 0.74 | 7.04 | 5.20 | 4.56 | 0.31 |
| | PP4712E1 | None | None | 0.70 | 6.40 | 4.50 | | |
| | PP4712E1 | None | None | 0.68 | 6.60 | 4.52 | | |
| | PP4712E1 | None | None | 0.71 | 6.46 | 4.62 | | |
| | PP4712E1 | None | None | 0.70 | 6.47 | 4.53 | | |
| | PP4712E1 | None | None | 0.71 | 5.90 | 4.21 | | |
| | PP4712E1 | None | None | 0.70 | 6.18 | 4.35 | | |
| 5 | PP4712E1 | None | 15% | 0.72 | 4.60 | 3.32 | 3.39 | 0.19 |
| | PP4712E1 | None | 15% | 0.67 | 5.43 | 3.66 | | |
| | PP4712E1 | None | 15% | 0.71 | 4.76 | 3.36 | | |
| | PP4712E1 | None | 15% | 0.71 | 4.53 | 3.22 | | |
| 6 | PP4712E1 | None | 30% | 0.72 | 3.98 | 2.85 | 2.95 | 0.17 |
| | PP4712E1 | None | 30% | 0.71 | 4.05 | 2.88 | | |
| | PP4712E1 | None | 30% | 0.72 | 3.97 | 2.85 | | |
| | PP4712E1 | None | 30% | 0.72 | 3.85 | 2.78 | | |
| | PP4712E1 | None | 30% | 0.68 | 4.88 | 3.31 | | |
| | PP4712E1 | None | 30% | 0.69 | 4.42 | 3.04 | | |
| | PP4712E1 | None | 30% | 0.70 | 4.14 | 2.88 | | |
| | PP4712E1 | None | 30% | 0.70 | 4.27 | 2.97 | | |
| 7 | PP4712E1 | 3% | None | 0.70 | 6.28 | 4.42 | 5.02 | 0.66 |
| | PP4712E1 | 3% | None | 0.70 | 6.48 | 4.56 | | |
| | PP4712E1 | 3% | None | 0.69 | 7.63 | 5.26 | | |
| | PP4712E1 | 3% | None | 0.66 | 8.80 | 5.84 | | |
| 8 | PP4712E1 | 3% | 15% | 0.70 | 5.19 | 3.61 | 3.71 | 0.30 |
| | PP4712E1 | 3% | 15% | 0.68 | 5.38 | 3.65 | | |
| | PP4712E1 | 3% | 15% | 0.65 | 6.40 | 4.14 | | |
| | PP4712E1 | 3% | 15% | 0.71 | 4.86 | 3.45 | | |
| 9 | PP4712E1 | 3% | 30% | 0.70 | 4.24 | 2.95 | 3.14 | 0.32 |
| | PP4712E1 | 3% | 30% | 0.71 | 4.20 | 3.00 | | |
| | PP4712E1 | 3% | 30% | 0.66 | 5.51 | 3.62 | | |
| | PP4712E1 | 3% | 30% | 0.69 | 4.35 | 3.01 | | |

(1) MILLAD ® 8C41 is a masterbatch of the nucleating agent MILLAD ® 3988. A level of 3% MILLAD ® 8C41 is equivalent to 0.3% MILLAD ® 3988.

The unique properties of the current invention are demonstrated in the data of Table 1. First, water vapor transmission rates were evaluated for the sample films herein. The data provided in Table 1 confirms that the inventive films of the current application have shown a reduction in water vapor transmission rate of about 38 percent when compared to unmodified control films. The incorporation of both a well dispersed nucleating agent and a water vapor transmission inhibitor, such as a hydrocarbon resin, in a metallized film according to the current invention may result in water vapor transmission rates of less than or equal to approximately 0.2 g/[m² day].

Next, the average moisture permeability coefficients (P_{H2O}) were evaluated. The average moisture permeability coefficient (P_{H2O}) for the inventive film of Structure 2, containing both a well distributed nucleating agent and 15% hydrocarbon resin, is less than the P_{H2O} for comparative Structure 5 and Structure 8. Structure 5 includes an equivalent amount (15%) of hydrocarbon resin but no nucleating agent. Structure 8, also includes an equivalent amount (15%) of hydrocarbon resin and a poorly distributed nucleating agent. The P_{H2O} for inventive Structure 3 is less than the P_{H2O} for comparative Structure 6 and Structure 9, each film having the same components as Structures 5 and 8 above, however each sample contains 30% hydrocarbon resin.

Further, the P_{H2O} for inventive Structures 2 and 3 are less than the P_{H2O} for Structure 1, which structure contains only nucleating agent and no hydrocarbon resin. Finally, the P_{H2O} for inventive Structures 2 and 3 are less than the P_{H2O} for comparative Structure 4, containing no nucleating agent and no hydrocarbon resin, and Structure 7, containing no hydrocarbon resin and a poorly distributed nucleating agent.

T-values aid in evaluating comparisons of the inventive film structures with similar film structures. As will be known to persons skilled in the art, a t-value is a measure of the statistical significance of an independent variable in explaining a dependent variable. T-values for the mean P_{H2O} of comparative samples herein are provided in Table 2, below.

TABLE 2

| Inventive Structure | Comparative Structure | t-value |
|---|---|---|
| Structure 2 | Structure 5 | 3.0 |
| Structure 2 | Structure 8 | 4.1 |
| Structure 3 | Structure 6 | 1.6 |
| Structure 3 | Structure 9 | 2.0 |
| Structure 2 | Structure 1 | 8.9 |
| Structure 3 | Structure 1 | 10 |
| Structure 2 | Structure 4 | 9.2 |
| Structure 3 | Structure 4 | 11 |

For the sample sizes used, t-values of 2.0 and greater indicate, with about 90% confidence, that the differences between the mean P_{H2O} values of the samples are statistically significant.

The t-value of 1.6 for Structure 6 indicates with about 85% confidence that the difference between P_{H2O} values for Structure 3 and Structure 6 is statistically significant.

It is noted that the foregoing examples have been provided merely for the purpose of explanation and are in no way to be construed as limiting of the present invention. While this disclosure has been described with reference to exemplary embodiments, it is understood that the words which have been used herin are words of description, rather than words of limitation. Changes may be made, within the purview of the appended claims, as presently stated and as amended, without departing from the scope and spirit of the present invention. Although this disclosure has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A polymeric film comprising a core layer comprising polypropylene, a nucleating agent and a hydrocarbon resin, wherein said core layer has a first side and a second side, said nucleating agent and said hydrocarbon resin being present in amounts sufficient to lower the average moisture permeability coefficient of the said film in comparison to the average moisture permeability coefficient of the film in the absence of either or both of said nucleating agent and said hydrocarbon resin.

2. The film of claim 1, wherein said film further comprises at least one of a first skin layer adjacent to said first side of said core layer and a second skin layer adjacent to said second side of said core layer.

3. The film of claim 2, wherein said film has a thickness of from about 5 microns to about 125 microns.

4. The film of claim 2, wherein said film has a thickness of from about 10 microns to about 62.5 microns.

5. The film of claim 2, wherein said film has a thickness of from about 10 microns to about 40 microns.

6. The film of claim 1, wherein said polypropylene in said core layer is isotactic polypropylene.

7. The film of claim 1, wherein said hydrocarbon resin in said core layer is selected from the group consisting of petroleum resins, terpene resins, styrene resins, cyclopentadiene resins, and saturated alicyclic resins.

8. The film of claim 7, wherein said hydrocarbon resin is a saturated alicyclic resin.

9. The film of claim 1, wherein said nucleating agent is selected from the group consisting of 4-dimethylbenzilidene sorbitol, sodium 2,2′-methylene bis(4, 6-di-tert-butylphenyl)phosphate), disodium(1R,2R, 3S,4S)-rel-bicyclo[2.2.1]heptane-2,3-dicarboxylic acid, N,N′-dicyclohexyl-2,6-naphthalenecarboxamide, substituted 1,3,5-benzenetrisamides, and combinations thereof.

10. The film of claim 1, wherein said nucleating agent is present in the polypropylene of said core layer in an amount up to about 3000 parts-per-million and said hydrocarbon resin is present in an amount of up to about 30 percent of said core layer.

11. The film of claim 1, wherein said nucleating agent is present in the polypropylene of said core layer in an amount from about 25 ppm to about 1000 ppm and said hydrocarbon resin is present in an amount of up to about 15 percent by weight of said core layer.

12. The film of claim 1, wherein said nucleating agent is present in the polypropylene of said core layer in an amount from about 50 ppm to about 200 ppm.

13. The film of claim 1, wherein said core layer comprises from about 70 percent by weight to about 85 percent by weight of said polypropylene.

14. The film of claim 2, wherein said first skin layer and/or said second skin layer comprise a polymer selected from the group consisting of low density polyethylene, linear low density polyethylene, medium density polyethylene, high density polyethylene, ethylene-propylene copolymers, butylene-propylene copolymers, ethylene-butylene copolymers, ethylene-propylene-butylene terpolymers, syndiotactic polypropylene, ethylene-vinyl acetate copolymers, ethylene-vinyl alcohol copolymers, polyvinyl alcohols, nylons, polyesters, polyamides, graft copolymers and combinations thereof.

15. A method for manufacturing a multi-layer polymeric film, comprising:
(a) forming a multi-layer film by coextruding at least
i) a first skin layer,
ii) a core layer, and
iii) a second skin layer, said core layer comprising polypropylene, nucleating agent, and hydrocarbon resin;
(b) orienting said film in a machine direction; and
(c) orienting said film in a transverse direction.

16. The method of claim 15, wherein the film further includes at least one coextruded tie layer located between said core layer and one of said skin layers.

17. The method of claim 16, wherein said tie layer comprises a polymer selected from the group consisting of syndiotactic polypropylene, low density polyethylene, linear low density polyethylene, medium density polyethylene, high density polyethylene, ethylene-propylene copolymers, butylene-propylene copolymers, ethylene-butylene copolymers, ethylene-propylene-butylene terpolymers, ethylene-vinyl acetate copolymers, ethylene-vinyl alcohol copolymers, nylons, polymers grafted with functional groups, and combinations thereof.

18. A polymeric barrier film, including a core layer comprising:
(a) a polypropylene resin having a nucleating agent substantially uniformly dispersed therein; and
(b) at least one hydrocarbon resin,
wherein said polymeric barrier film has an average moisture permeability coefficient that is lower than the average moisture permeability coefficient of the polymeric barrier film in the absence of either or both said nucleating agent and said hydrocarbon resin.

19. The polymeric barrier film of claim 18, wherein said polypropylene resin is an isotactic polypropylene resin.

20. The polymeric barrier film of claim 18, wherein said polypropylene resin is a syndiotactic polypropylene resin.

21. The polymeric barrier film of claim 18, further comprising a skin layer on at least one side of said core layer, and optionally at least one tie layer between said core layer and said skin layer.

22. The polymeric barrier film of claim 18, wherein said film has been oriented in at least one direction.

23. The polymeric barrier film of claim 18, wherein said film has been biaxially oriented.

24. The polymeric barrier film of claim 18, wherein said film comprises a plurality of layers.

25. The polymeric barrier film of claim 18, comprising protective polymeric coatings on either or both exterior surfaces of said film.

26. The polymeric barrier film of claim 18, wherein said at least one hydrocarbon resin comprises a low molecular weight hydrocarbon resin.

27. The polymeric barrier film of claim 26, wherein said low molecular weight hydrocarbon resin is selected from the group consisting of hydrogenated hydrocarbon, ethylindene, butadiene, isoprene, piperylene, pentylene, polystyrene, methylstyrene, vinyltoluene, indene, polycylcopentadiene, polyterpenes, polymers of hydrogenated aromatic hydrocarbons, alicyclic hydrocarbon resins and combinations thereof.

28. The polymeric barrier film of claim 26, wherein said low molecular weight hydrocarbon resin has a softening point of from about 60° C. to about 180° C.

29. The polymeric barrier film of claim 26, wherein said low molecular weight hydrocarbon resin has a softening point from about 80° C. to about 130° C.

30. The polymeric barrier film of claim 18, wherein said hydrocarbon resin comprises up to about 30 weight percent of said core layer.

31. The polymeric barrier film of claim 18, wherein said hydrocarbon resin comprises up to about 15 weight percent of said core layer.

32. The polymeric barrier film of claim 21, wherein said skin layer comprises a polymer selected from the group consisting of low density polyethylene, linear low density polyethylene, medium density polyethylene, high density polyethylene, ethylene-propylene copolymers, butylene-propylene copolymers, ethylene-butylene copolymers, ethylene-propylene-butylene terpolymers, syndiotactic polypropylene, ethylene-vinyl acetate copolymers, ethylene-vinyl alcohol copolymers, polyvinyl alcohols, nylons, polyesters, polyamides, graft copolymers and combinations thereof.

33. The polymeric barrier film of claim 21, wherein said tie layer comprises a polymer selected from the group consisting of syndiotactic polypropylene, low density polyethylene, linear low density polyethylene, medium density polyethylene, high density polyethylene, ethylene-propylene copolymers, butylene-propylene copolymers, ethylene-butylene copolymers, ethylene-propylene-butylene terpolymers, ethylene-vinyl acetate copolymers, ethylene-vinyl alcohol copolymers, nylons, polymers grafted with functional groups, and combinations thereof.

34. The polymeric barrier film of claim 18, wherein said nucleating agent is selected from the group consisting of 4-dimethylbenzilidene sorbitol, sodium 2,2′-methylene bis(4, 6-di-tert-butylphenyl)phosphate), disodium(1R,2R, 3S,4S)-rel-bicyclo[2.2.1]heptane-2,3-dicarboxylic acid, N,N′-dicyclohexyl-2,6-naphthalenecarboxamide, substituted 1,3,5-benzenetrisamides and combinations thereof.

35. A polypropylene film comprising:
(a) a first skin layer;
(b) a second skin layer; and
(c) a core layer comprising about 85 percent by weight of a nucleated isotactic polypropylene and about 15 percent by weight of a hydrocarbon resin.

36. The film of claim 35, having a P_{H2O} moisture transmission coefficient less than about 4.0 g mil/m² day.

37. The film of claim 35, having a P_{H2O} moisture transmission coefficient less than about 3.0 g mil/m² day.

38. The film of claim 35, having a P_{H2O} moisture transmission coefficient less than about 2.8 g mil/m² day.

39. The film of claim 35, wherein said nucleated isotactic polypropylene comprises at least about 70 percent by weight of said core layer and said hydrocarbon resin comprises up to about 30 percent by weight of said core layer.

40. A polymeric barrier film including a core layer comprising:
(a) a polypropylene resin having a nucleating agent substantially uniformly dispersed therein; and
(b) at least one additive, other than said nucleating agent, comprising at least one water vapor transmission inhibitor in an amount sufficient to lower the average moisture permeability coefficient of the polymeric barrier film in comparison to the average moisture permeability coefficient of the polymeric barrier film in the absence of the at least one water vapor transmission inhibitor.

41. The polymeric barrier film of claim 40, wherein said polypropylene resin is an isotactic polypropylene resin.

42. The polymeric barrier film of claim 40, wherein said polypropylene resin is a syndiotactic polypropylene resin.

43. The polymeric barrier film of claim 40, further comprising a skin layer on at least one side of said core layer, and optionally at least one tie layer intermediate said core layer and said skin layer.

44. The polymeric barrier film of claim 40, wherein said film has been oriented in at least one direction.

45. The polymeric barrier film of claim 40, wherein said film has been biaxially oriented.

46. The. polymeric barrier film of claim 40, wherein said film comprises a plurality of layers.

47. The polymeric barrier film of claim 40, further comprising protective polymeric coatings on either or both exterior surfaces of said film.

48. The polymeric barrier film of claim 40, wherein said at least one additive comprises a low molecular weight hydrocarbon resin.

49. The polymeric barrier film of claim 43, wherein said skin layer comprises a polymer selected from the group consisting of low density polyethylene, linear low density polyethylene, medium density polyethylene, high density polyethylene, ethylene-propylene copolymers, butylene-propylene copolymers, ethylene-butylene copolymers, ethylene-propylene-butylene terpolymers, syndiotactic polypropylene, ethylene-vinyl acetate copolymers, ethylene-vinyl alcohol copolymers, polyvinyl alcohols, nylons, polyesters, polyamides, graft copolymers and combinations thereof.

50. The polymeric barrier film of claim 43, wherein said tie layer comprises a polymer selected from the group consisting of syndiotactic polypropylene, low density polyethylene, linear low density polyethylene, medium density polyethylene, high density polyethylene, ethylene-propylene copolymers, butylene-propylene copolymers, ethylene-butylene copolymers, ethylene-propylene-butylene terpolymers, ethylene-vinyl acetate copolymers, ethylene-vinyl alcohol copolymers, nylons, polymers grafted with functional groups, and combinations thereof.

51. The polymeric barrier film of claim 40, wherein said nucleating agent is selected from the group consisting of 4-dimethylbenzilidene sorbitol, sodium 2,2′-methylene bis(4, 6-di-tert-butylphenyl)phosphate), disodium(1R,2R, 3S,4S)-rel-bicyclo[2.2.1]heptane-2,3-dicarboxylic acid, N,N′-dicyclohexyl-2,6-naphthalenecarboxamide, substituted 1,3,5-benzenetrisamides and combinations thereof.

52. A process of making a polymeric barrier film, comprising adding to at least one layer of a nucleated polypropylene film, at least one water vapor transmission inhibitor in an amount sufficient to lower the average moisture permeability coefficient of the polymeric barrier film in comparison to the average moisture permeability coefficient of the polymeric barrier film in the absence of said at least one water vapor transmission inhibitor.
